(19) United States
(12) Patent Application Publication
(10) Pub. No.: US 2026/0204731 A1
(43) Pub. Date: Jul. 16, 2026

(54) BATTERY CELL

(71) Applicant: MILWAUKEE ELECTRIC TOOL CORPORATION, Brookfield, WI (US)

(72) Inventors: Joshua Pender, Glendale, WI (US); Aditya Subramanian, Milwaukee, WI (US); Alexei Gavrilov, Hockessin, DE (US); Jacob N. Nemec, Waldo, WI (US)

(21) Appl. No.: 19/136,090

(22) PCT Filed: Dec. 19, 2023
(86) PCT No.: PCT/US2023/084932

§ 371 Date: Jun. 5, 2025

Related U.S. Application Data
(60) Provisional application No. 63/435,073, filed on Dec. 23, 2022.

(51) Int. Cl. H01M 50/30; H01M 10/0525; H01M 50/105

(52) U.S. Cl. CPC H01M 50/394; H01M 10/0525; H01M 50/105

(57) ABSTRACT

A secondary battery includes a flexible body portion, an electrochemical formation, a cathode, an anode, and a gas-release device. The flexible body portion defines an internal volume. The electrochemical formation is positioned within the internal volume and includes layered anode and cathode materials interlaced with separators therebetween and wetted with electrolyte. The cathode is in electrical communication with the electrochemical formation and extends from the body portion. The anode is in electrical communication with the electrochemical formation and extends from the body portion. The gas-release device is in communication with the internal volume and relieves gas generated inside the body portion.

### CROSS-REFERENCE TO RELATED APPLICATIONS

The present application claims priority to U.S. provisional application number 63/435,073, filed Dec. 23, 2022, the entire contents of which are incorporated by reference herein.

### FIELD

The present disclosure relates to a battery cell for use in a battery pack.

### BACKGROUND

Rechargeable battery packs typically store electrical power in a plurality of individual battery cells contained within the housing thereof.

### SUMMARY

In one aspect, the disclosure provides a secondary battery. The secondary battery includes a flexible body portion, an electrochemical formation, a cathode, an anode, and a gas-release device. The flexible body portion defines an internal volume. The electrochemical formation is positioned within the internal volume and includes layered anode and cathode materials interlaced with separators therebetween and wetted with electrolyte. The cathode is in electrical communication with the electrochemical formation and extends from the body portion. The anode is in electrical communication with the electrochemical formation and extends from the body portion. The gas-release device is in communication with the internal volume and relieves gas generated inside the body portion.

In another aspect, the disclosure provides a method for forming a secondary battery cell. The method includes forming a body portion including a peripheral edge and an internal volume; positioning a gas-release device within the body portion, the gas-release device being in one-way fluid communication with the internal volume; forming, within the body portion, an electrochemical formation including layered anode and cathode materials interlaced with separators therebetween and wetted with electrolyte; coupling a cathode to the body portion such that the cathode extends from the body portion, the cathode in communication with the electrochemical formation; coupling an anode to the body portion such that the anode extends from the body portion, the cathode in communication with the electrochemical formation; and forming a sealed edge of the body portion along the peripheral edge that encloses the internal volume.

### BRIEF DESCRIPTION OF THE DRAWINGS

FIG. 1 is a schematic view of a battery cell including a vent, according to embodiments disclosed herein.

FIG. 2 is a schematic view of the vent of FIG. 1.

FIG. 3 is a schematic view of a battery cell including a vent, according to embodiments disclosed herein.

FIG. 4 is a schematic view of the vent of the battery cell of FIG. 3.

FIG. 5 is a schematic view of another vent for use with the battery cell of FIG. 3.

FIG. 6 is a schematic view of another vent for use with the battery cell of FIG. 3.

FIG. 7 is a schematic view of another vent for use with the battery cell of FIG. 3.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

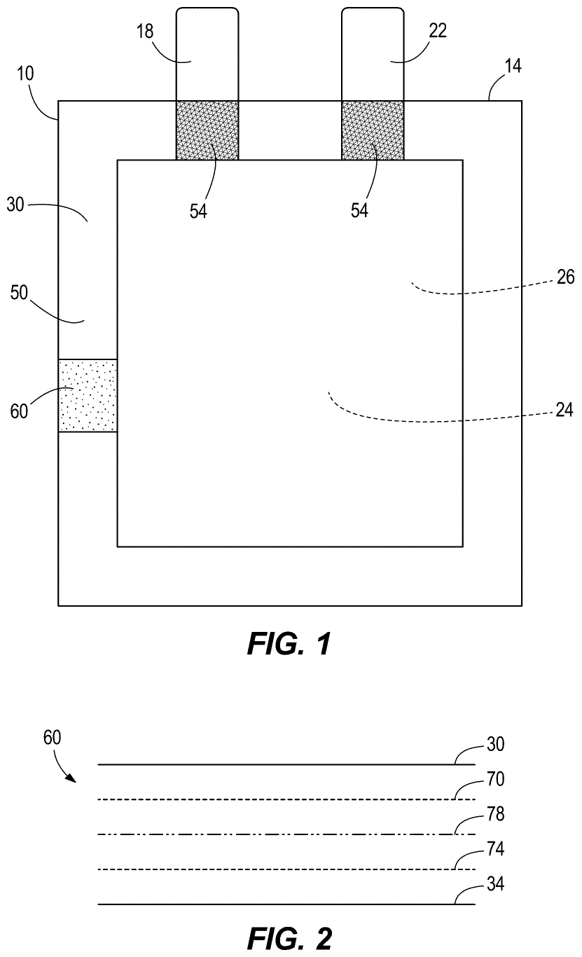

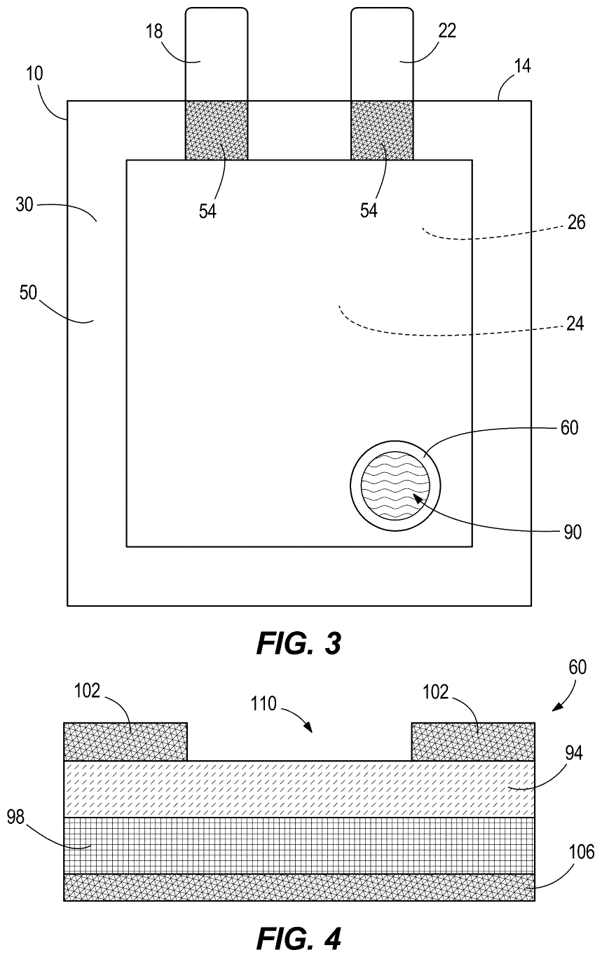

FIGS. 1 and 3 illustrate exemplary embodiments of a rechargeable battery cell 10 (e.g., a secondary battery cell). The battery cell 10 is a pouch-style battery cell having a pouch or body portion 14, a cathode 18 (e.g., positive terminal) extending outwardly from the body portion 14, and an anode 22 (e.g., negative terminal) extending outwardly from the body portion 14. In the illustrated embodiments, both the anode 22 and cathode 18 exit the body portion 14 along a single edge thereof. In other embodiments, the anode 22 and cathode 18 may exit from the body portion 14 at any location as needed to, for instance, minimize the distances included in the resulting electrical connections.

The body portion 14 of the battery cell 10 includes an external semi-flexible pouch enclosing a sealed internal battery volume (not shown) therein. The sealed battery volume, in turn, contains a number of layered anode and cathode materials interlaced with separators therebetween and wetted with electrolyte to produce a rechargeable lithium-polymer cell. In some embodiments, the layered anode and cathode materials and separators define an electrochemical formation that may be in a spiral or jelly roll configuration 24. In other embodiments, the layered anode and cathode materials and separators may have another electrochemical formation, such as a stacked configuration. The specific layout of the cell may be determined by the desired capabilities of the finished battery pack 10.

While the illustrated battery cell 10 is generally based on lithium-ion technology, it is understood that, in other embodiments, different forms of rechargeable battery chemistry or layout may be used. In the illustrated embodiment, the construction of the internal battery volume 26 is such that the body portion 14 of the cell 10 is capable of storing at least 600 Wh/L when fully charged.

In the illustrated embodiment, the body portion 14 of each cell 50 forms a substantially rectangular prism shape including a generally planar top wall 30 and a generally planar bottom wall 34 suitable for stacking. The top and bottom walls 30, 34 are coupled to one another to define a peripheral edge of the body portion 14. The top wall 30 and the bottom wall 34 may be formed from any suitable material (such as a resin material). The body portion 14 defines a cell height (into the page), a cell width, and a cell length. As shown in FIGS. 1 and 3, the overall shape of the body portion 14 is generally flat and plate-like such that the cell length and cell width are proportionally much larger than the cell height. While the illustrated body portion 14 is generally rectangular in cross-sectional shape (taken along a cutting plane set parallel to the top and bottom walls 30, 34), it is understood that in other embodiments different cross-sectional sizes and shapes may be used while still maintaining the overall “flat” profile. For example, the exterior profile of the body portion 14 of each cell 10 may be modified to correspond with the size and shape of an available interior volume of a battery pack in which the battery cell 10 is used.

Further with respect to FIGS. 1 and 3, the body portion 14 of each cell includes a seal that couples the top wall and the bottom wall to one another. The seal extends inwardly from each side of the peripheral edge of the body portion to form a sealed edge 50 that extends about a perimeter of the battery cell 10. The internal battery volume 26 of the body portion 14 is, therefore, defined by the sealed edge 50. As shown, the cathode 18 and the anode 22 extend between the top and bottom walls of the body portion 14. Accordingly, the seal also couples the cathode 18 and the anode 22 to the inner surfaces of each of the top and bottom walls. The seal may be accomplished in any suitable way (e.g., heat sealing, vacuum sealing, adhesive, etc.). In some embodiments, an additional sealing tape 54 may be positioned between the cathode 18 and the anode 22 and the inner surfaces of the top and bottom walls 30, 34.

With continued reference to FIGS. 1 and 3, the battery cell 10 may further include a one-way vent 60 (e.g., a gas-release device). That is, the vent 60 is configured to allow venting of internal gases within the internal battery volume 26 while preventing the ingress of external gases or moisture. The vent 60 serves two primary purposes. The first purpose is to simplify manufacturing of the battery cell 10 by eliminating the need to vent and re-seal pouch cells following initial electrochemical formation of the cell. The second purpose is to improve safety of pouch cells by acting as a shutdown vent during abnormal cell operation such as overcharge, overdischarge, or thermal runaway.

In the embodiment of FIGS. 1 and 2, the vent 60 is positioned between the inner surfaces of the top and bottom walls 30, 34 and extends through the sealed edge 50. Accordingly, the seal is created around the vent 60. That is, the vent 60 extends from the peripheral edge of the body portion 14 to the internal battery volume 26 to allow one-way communication of gases from the internal battery volume 62 to an outside of the body portion 14.

In the embodiment of FIG. 1, the vent 60 is formed from a multilayer film. The film includes a first or top layer 70, a second or bottom layer 74, and a third or middle layer 78 positioned between the top layer 70 and the bottom layer 74. The top layer 70 is positioned adjacent and coupled to the inner surface of the top wall 30 in the area of the sealed edge 50, while the bottom layer 74 is positioned adjacent and coupled to the inner surface of the bottom wall 34 in the area of the sealed edge 50. Each of the top layer 70 and the bottom layer 74 includes a thin, hydrophobic, and non-porous film. The film used for the top layer 70 and bottom layer 74 may be formed from one or more of the following materials: polyethylene terephthalate (PET), mixed cellulose, expanded polytetrafluoroethylene (ePTFE), polypropylene (PP), polyvinylidene difluoride (PVDF), and/or acrylic copolymers. The middle layer is formed of a thin, elastomeric, porous film. The middle layer 78 is configured to expand upon pressure buildup inside the internal battery volume 26 to allow venting and to relax after a pressure within the internal battery volume 26 and a pressure external to the battery cell 10 are equalized. Despite the middle layer 78 expanding and contracting, the middle layer 78 is configured to remain in contact with the seal to maintain the seal of the body portion 14. The film used for the middle layer 78 may have a tensile modulus ranging from about 225 ksi to about 450 ksi and a tear resistance ranging from about 475 g-force to about 2225 g-force. The film used for the middle layer 78 may be formed of a polymer. For example, the film used for the middle layer 78 may be formed from one or more of the following materials: polyetheretherketone (PEEK), polyaryletherketone (PAEK), polyphenylsulfone (PPSU), ethylene chlorotrifluoroethylene (ECTFE), polyvinylidene fluoride (PVDF), polyacrylamide (PARA), polyetherimide (PEI), thermoplastic polyimide (TPI), and/or polyacetal (POM).

In the embodiment of FIG. 3, the vent 60 is positioned between the inner surfaces of the top wall 30 and the bottom wall 34 and within the internal battery volume 26. In the illustrated embodiment, the vent 60 is positioned adjacent the inner surface of the top wall 30, although in other embodiments, the vent 60 may be positioned adjacent the inner surface of the bottom wall 34. Regardless, the vent 60 is positioned between the respective inner surface and the jelly roll 24 (or other anode/cathode configuration).

In the embodiment of FIG. 3, the vent 60 is a multilayer membrane that is coupled to and circumscribes an aperture 90 in the top wall 30. As shown in FIG. 4, the multilayer membrane 60 includes a porous, hydrophobic, and oleophobic membrane layer 94 and a non-woven support layer 98, each of which is positioned between a first adhesive layer 102 and a second adhesive layer 106. The first adhesive layer 102 is configured to couple the vent 60 to the inner surface top wall 30, while the second adhesive layer 106 is configured to couple the vent 60 to the jelly roll 24 (or other structure within the internal battery volume 26). In the illustrated embodiment, the adhesive layers 102, 106 may be formed from silicone, acrylic, or a combination of silicone and acrylic. The membrane layer 94 is positioned and coupled between the first adhesive layer 102 and the support layer 98, while the support layer 98 is positioned between the membrane layer 94 and the second adhesive layer 106. The first adhesive layer 102 is formed with an aperture 110 extending therethrough that is aligned with (or otherwise at least partially overlaps) the aperture 90 in the top wall 30. The membrane layer 94 extends across the aligned apertures 90, 110 of the first adhesive layer 102 and the inner surface of the top wall 30. Similarly, the support layer 98 and the second adhesive layer 106 also extend across the aligned apertures 90, 100.

The membrane layer 94 may include one or more of the following materials: mixed cellulose ester (MCE) or expanded polytetrafluoroethylene (ePTFE). The support layer 98 is preferably formed from one or more of the following materials: polyethylene terephthalate (PET), mixed cellulose, expanded polytetrafluoroethylene (ePTFE), polypropylene (PP), polyvinylidene difluoride (PVDF), and/or acrylic copolymers.

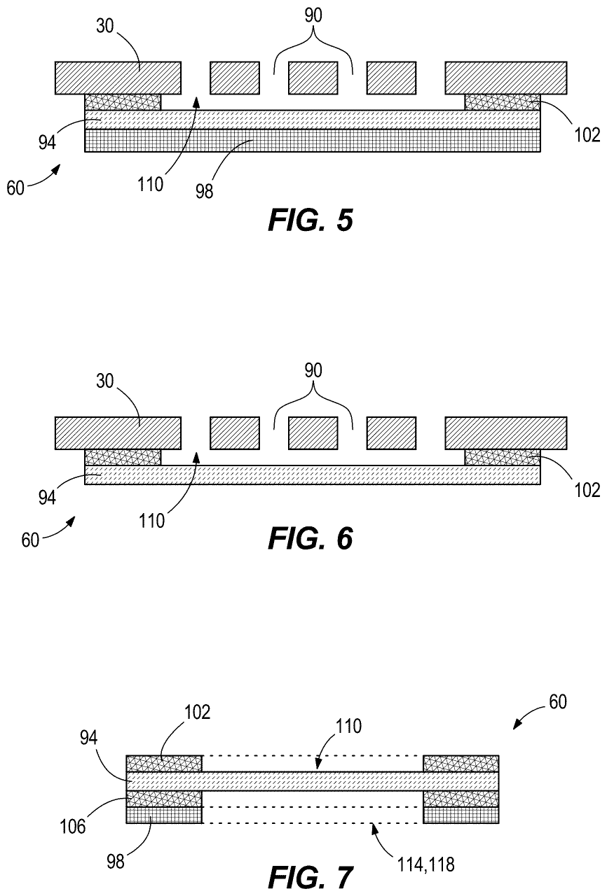

In some embodiments, the aperture 110 in the first adhesive member 102 may be substantially the same size as or slightly larger than the aperture 90 in the top wall 30. In the illustrated embodiment of FIG. 4, there is a single aperture 90 in the top wall 30 and a single aperture 110 in the first adhesive layer 102, but in other embodiments, there may be a plurality of apertures 90 in the top wall 30 and/or a plurality of apertures 110 in the first adhesive layer 102. For example, in some embodiments, the plurality of apertures 90 in the top wall 30 may align with one of the plurality of apertures 110 in the first adhesive layer 102. In another example, the plurality of apertures 90 in the top wall 30 may be staggered relative to the plurality of apertures 110 in the first adhesive layer 102. In still another example (FIG. 5), the plurality of apertures 90, 110 in the top wall 30 or the first adhesive layer 102 may be circumscribed by a single aperture 90, 110 in the other of the top wall 30 or the first adhesive layer 102. As shown in FIG. 5, the top wall 30 has a plurality of apertures 90 that are circumscribed by a single aperture 110 in the first adhesive layer 102 of the vent 60. In some embodiments, the aperture 110 (or each of the apertures) in the first adhesive layer 102 may have a diameter ranging from 1.6 mm to 20 mm, and in other embodiments, the aperture 110 (or each of the apertures) in the first adhesive layer 102 may have a diameter ranging from 1.6 mm to 5.5 mm. Also, the configuration of the layers of the vent of FIG. 4 is merely exemplary and may be configured in other ways. For example, in some embodiments, the second adhesive layer 106 (FIGS. 5 and 6) and/or the support layer 94 (FIG. 6) may be omitted. In still other embodiments, the second adhesive layer 106 may be positioned between the membrane layer 94 (FIG. 7) and the support layer 98. Also, each of the support layer 98 and the second adhesive layer 106 may have apertures 114, 118 (FIG. 7) that are aligned with the apertures 90, 110 of the top wall 30 and the first adhesive layer 102.

In the illustrated embodiments of FIGS. 3-7, the total thickness of the vent 60 may range from 0.16 mm to 0.34 mm. Also, the vent 60 is usable within a temperature range of −40 degrees Celsius to 125 degrees Celsius. In some embodiments, the vent 60 is capable of accommodating an airflow rate of 9 ml/min/cm² to 10,500 ml/min/cm² at 70 mbar. In some embodiments, the vent 60 is capable of accommodating an airflow rate of 290 ml/min/cm² to 19,000 ml/min/cm² at 70 mbar. In other embodiments, the vent 60 is capable of accommodating an airflow rate of greater than 32 ml/min/mm² at 10 kPa. In some embodiments, the vent 60 has a water-holding pressure of 15 kPa for 15 minutes, a retention rating of greater than 95% at 0.3 μm, and an oil rating of greater than 7.

Although the disclosure has been described in detail with reference to certain preferred embodiments, variations and modifications exist within the scope and spirit of one or more independent aspects of the disclosure as described.

What is claimed is:

1. A secondary battery cell comprising:
a flexible body portion defining an internal volume;
an electrochemical formation positioned within the internal volume and including layered anode and cathode materials interlaced with separators therebetween and wetted with electrolyte;
a cathode in electrical communication with the electrochemical formation and configured to extend from the body portion;
an anode in electrical communication with the electrochemical formation and configured to extend from the body portion; and
a gas-release device in communication with the internal volume and configured to relieve gas generated inside the body portion.

2. The secondary battery cell of claim 1, wherein the gas-release device eliminates the need to vent and reseal the pouch cell after the electrochemical formation is initially formed.

3. The secondary battery cell of claim 1, wherein the gas-release device allows venting of the gas generated inside the internal volume while preventing ingress of external moisture or gases.

4. The secondary battery cell of claim 1, wherein the gas-release device acts as a safety vent to shut down the secondary battery cell during abnormal operation.

5. The secondary battery cell of claim 4, wherein the abnormal operation is caused by an overcharge condition or a thermal runaway condition.

6. The secondary battery cell of claim 1, wherein the gas-release device is formed as a film and is integrated along a sealed edge of the body portion.

7. The secondary battery cell of claim 6, wherein the film is a multilayer film including a first layer positioned adjacent a first inner surface of the sealed edge, a second layer positioned adjacent a second inner surface of the sealed edge, and a third layer positioned between the first layer and the second layer, the third layer configured to expand and relax.

8. The secondary battery cell of claim 7, wherein the first layer and the second layer are formed from a hydrophobic and non-porous film, and wherein the third layer is formed from am elastomeric and porous film.

9. The secondary battery cell of claim 8, wherein the first layer and the second layer are formed from one or more of the following materials: polyethylene terephthalate (PET), mixed cellulose, expanded polytetrafluoroethylene (ePTFE), polypropylene (PP), polyvinylidene difluoride (PVDF), and acrylic copolymers.

10. The secondary battery cell of claim 8, wherein the third layer is formed from one or more of the following materials: polyetheretherketone (PEEK), polyaryletherketone (PAEK), polyphenylsulfone (PPSU), ethylene chlorotrifluoroethylene (ECTFE), polyvinylidene fluoride (PVDF), polyacrylamide (PARA), polyetherimide (PEI), thermoplastic polyimide (TPI), and polyacetal (POM).

11. The secondary battery cell of claim 1, wherein the gas-release device is formed as a selectively permeable membrane embedded in the internal volume.

12. The secondary battery cell of claim 11, wherein the selectively permeable membrane is a multilayer membrane including a first adhesive layer, a membrane layer, and a support layer, the membrane layer positioned between the first adhesive layer and the support layer.

13. The secondary battery cell of claim 12, wherein the body portion includes a first wall, a second wall opposite the first wall, and a first aperture extending through the first wall, wherein the first adhesive layer has second aperture extending therethrough, the first adhesive layer coupled to an inner surface of the first wall such that the second aperture at least partially overlaps the first aperture.

14. The secondary battery cell of claim 12, the multilayer membrane further includes a second adhesive layer coupled to the support layer, the second adhesive layer configured to couple the multilayer membrane to the electrochemical formation.

15. The secondary battery cell of claim 12, wherein the membrane layer is formed from a porous, hydrophobic, oleophobic material and the support layer is formed from a non-woven material.

16. The secondary battery cell of claim 15, wherein
the first adhesive layer is formed from silicone, acrylic, or a combination of silicone and acrylic,
the membrane layer is formed from one or more of the following materials: mixed cellulose ester (MCE) and expanded polytetrafluoroethylene (ePTFE), and
the support layer is formed from one or more of the following materials: polyethylene terephthalate (PET), mixed cellulose, expanded polytetrafluoroethylene (ePTFE), polypropylene (PP), polyvinylidene difluoride (PVDF), and acrylic copolymers.

17. A method for forming a secondary battery cell, the method comprising:
forming a body portion including a peripheral edge and an internal volume;
positioning a gas-release device within the body portion, the gas-release device being in one-way fluid communication with the internal volume;
forming, within the body portion, an electrochemical formation including layered anode and cathode materials interlaced with separators therebetween and wetted with electrolyte;
coupling a cathode to the body portion such that the cathode extends from the body portion, the cathode in communication with the electrochemical formation;
coupling an anode to the body portion such that the anode extends from the body portion, the cathode in communication with the electrochemical formation; and
forming a sealed edge of the body portion along the peripheral edge that encloses the internal volume.

18. The method of claim 17, wherein forming a gas-release device includes forming the gas-release device in the sealed edge.

19. The method of claim 18, wherein the gas-release device includes a multilayer film including a first layer positioned adjacent a first inner surface of the sealed edge, a second layer positioned adjacent a second inner surface of the sealed edge, and a third layer positioned between the first layer and the second layer, the third layer configured to expand and relax.

20. The secondary battery cell of claim 19, wherein the first layer and the second layer are formed from a hydrophobic and non-porous film, and wherein the third layer is formed from am elastomeric and porous film.

21. The method of claim 17, wherein forming a gas-release device includes forming the gas-release device in the internal volume.

22. The method of claim 21, wherein gas-release device is a selectively permeable multilayer membrane including a first adhesive layer, a membrane layer, and a support layer, the membrane layer positioned between the first adhesive layer and the support layer.

23. The method of claim 22, wherein forming the body portion includes forming a first wall, a second wall opposite the first wall, and a first aperture extending through the first wall, and further comprising coupling the first adhesive layer to an inner surface of the first wall such that a second aperture in the first adhesive layer at least partially overlaps the first aperture.

24. The method of claim 22, wherein the membrane layer is formed from a porous, hydrophobic, oleophobic material and the support layer is formed from a non-woven material.
